(19) United States
(12) Patent Application Publication
(10) Pub. No.: US 2006/0116864 A1
(43) Pub. Date: Jun. 1, 2006

(54) Safe, secure resource editing for application localization with automatic adjustment of application user interface for translated resources

(75) Inventors: Barry McHugh, Dublin (IE); David Ahs, Dublin (IE); Jan-Roelof Falkena, Seattle, WA (US); Robert Grimes, Dublin (IE); Terry Farrell, Dublin (IE); Alexei Soloveitchik, Dublin (IE)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/042,470

(22) Filed: Jan. 24, 2005

Related U.S. Application Data
(63) Continuation-in-part of application No. 11/002,773, filed on Dec. 1, 2004.

(51) Int. Cl. G06F 17/28

(52) U.S. Cl. 704/2

(57) ABSTRACT

Embodiments of the present invention relate to methods, systems and computer-readable media for external localization of a software product. This external localization involves loading a base product having one or more calls to an operating system (or an API) to load language specific data. The calls are intercepted after the resource is loaded into a Resource loader, and queried whether the resource is identified in a restricted resource list such as a code signed dynamic linked library. If so, the translated resource is loaded from a specified language package. The loaded, and translated, resource is then checked against validation rules (which are also protected in a code signed resource list) to see if it is safe to use. If the resource is not on the list or the translated resource is not safe to use, the original resource is simply transferred to the application without modification from the resource loader, i.e., loaded from the base language file. This generates a localized product using a limited set of language specific data covering most situations. The translated or localized dialogs are then resized to accommodate the translated resource through one or more of a series of functions including automatic sizing, automatic layout descriptions, pre-calculated permissible sizes, and proportional stretching of the dialog sizes.

### Cross Reference To Related Applications

This application is a continuation-in-part of U.S. patent application Ser. No. 11/002773, filed Dec. 1, 2004, which is hereby incorporated by reference herein in its entirety.

### TECHNICAL FIELD

The invention relates generally to the field of computer software products. More particularly, the invention relates to methods and systems for producing language specific versions of a software product.

### BACKGROUND OF THE INVENTION

Software products of all types, whether operating systems or various types of application programs, are frequently provided in multiple “localized”, language specific versions. For instance, a software product may initially be developed in a specific language such as English. Once this original, or “base” product has been developed and tested, localized versions, in a language appropriate to the market for which the product is intended, may be developed. For example, a product originally developed in English in the United States may be localized to produce a Japanese language version for sale in Japan. The process of creating a localized version, or translation, is herein referred to as “localization.”

A common method of localization is known as internal localization. Internal localization typically involves changing the resources of the original software product to produce the localized version. For example, all of the elements of the user interface, messages, help information, and other language specific parts of the software product are translated and re-built. Since the resources of the software product are revised and rebuilt, testing is required for each internally localized version generated, in addition to the base product. The building of the dynamic link libraries (DLLs) correctly is a complex process for many applications, and the tools involved are often proprietary or secret. Since testing is labor intensive, this method can be extremely expensive. In addition to being expensive, internal localization, due to the long time required to test a software product, results in a very slow delivery of localized versions of software products. This is known as the multiple language user interface (MUI) approach where all of the resources for each language are grouped into resource files. These files are usually stored in a folder named after the language.

It is with respect to these needs that the present invention has been developed.

### SUMMARY OF THE INVENTION

An embodiment of the present invention is a system and method for providing translation, or localization, of a software product that, after the application is loaded in its base language, transparently examines each call for a resource to be loaded from a multiple language user interface dynamic linked library (MUI DLL), checks whether the particular called resource is in a secure resource list, and, if it is in the secure resource list, loads that resource from an alternative location (without the knowledge of the application). If the resource is not in the secure resource list, then the resource simply is not loaded.

The requested resource call is checked against the secure resource list. If the resource is in the secure resource list, the rules associated with that resource are retrieved (also from the secure resource list). The translated, i.e. localized, resource itself is retrieved from a “Language Pack” or Glossary for the requested language. The resource rules are then verified with the translated resource, and, if necessary, the dialogs associated with the resource are padded or resized to accommodate the anticipated size of the localized language dialog. This resizing process involves subjecting the translated resource to one or more of a series of algorithmic functions to determine the appropriate resizing for the resource. For example, an automatic layout description engine may be used or pre-calculated sizes may be used. The localized resource loaded is then passed to the application, or calling operating system, for processing. In this way, the application operates in its base language with selected localization taking place in accordance with the predefined resource rules.

In accordance with other aspects, the present invention relates to a system for localization, i.e. translation, of a software product that has a processor and a memory coupled with and readable by the processor. The memory contains a series of instructions that, when executed by the processor, cause the processor to load an application to an operating system wherein one of the application or the operating system places one or more calls to a resource loader to load a resource, intercept the call in the resource loader after the called resource has been retrieved to the loader, convert the resource to a language specific localized resource and transmit the localized resource to the operating system if the called resource matches one or more predetermined resource rules. If the translated resource does not match the rules, i.e. rule compliance cannot be verified, the called resource is not translated but is transmitted in its original form to the operating system via the resource loader

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates, conceptually, a safe, secure localization environment according to one embodiment of the present invention.

FIG. 2 illustrates an example of a suitable computing system environment on which embodiments of the invention may be implemented.

FIG. 3 is a flowchart illustrating load time operations in a software product utilizing safe, secure localization according to one embodiment of the present invention.

FIG. 4 is an overall process flow diagram of runtime dialog sizing in accordance with embodiments of the present invention.

FIG. 5 is a flow diagram illustrating one method of user interface adjustment after translation utilizing layout descriptions in accordance with the present invention.

FIG. 6 is a flow diagram illustrating a method of user interface adjustment after translation utilizing best matching in accordance with the present invention.

FIG. 7 is a flow diagram illustrating another method of user interface adjustment after translation utilizing heuristics in accordance with the present invention.

FIG. 8 is a flow diagram illustrating another method of user interface adjustment after translation using proportionate stretching.

FIG. 9 is a flow diagram illustrating hotkey handling in accordance with an embodiment of the present invention.

FIG. 10 is a flow diagram illustrating further hotkey handling in accordance with an embodiment of the present invention.

### DETAILED DESCRIPTION OF THE INVENTION

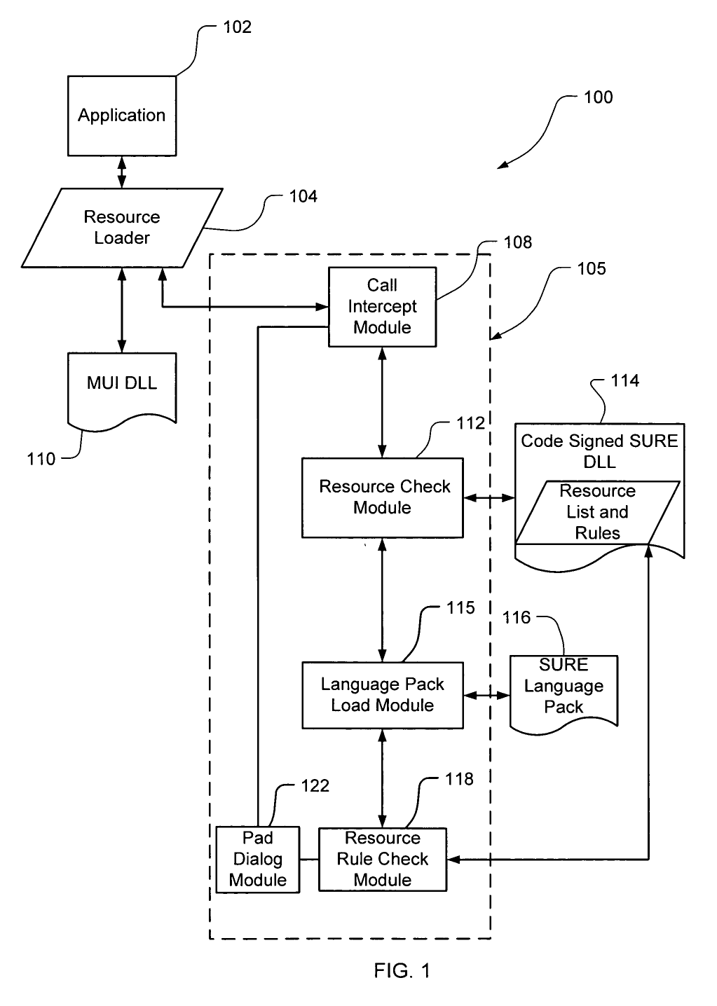

FIG. 1 illustrates, conceptually, a secure resource (hereinafter SURE) localization system 100 according to one embodiment of the present invention. In an application such as a Microsoft® Windows operating system or Office® application, when the application 102 is loaded into the computer operating system, a call is made to a resource loader module 104. It is to be understood throughout this detailed description that the application 102 is exemplary only. The call may be made by an application, data including various data structures, Application Program Interface (API) or operating system. The resource loader module 104 checks to see what language is called for by the application 102 and goes to the appropriate language folder. From this language folder, the loader 104 retrieves the called resource preferably from a multiple language user interface dynamic link library (MUI DLL) 110. The resource called is then loaded and transferred to the operating system. The notion of storing the resources in a MUI DLL 110 is also only exemplary. The resources can be stored in any format range from files to databases (or even remote locations such as locations accessible via the internet).

However, in embodiments of the present invention, an interception of the resource is made in the resource loader 104 before transfer to the calling application.

The system 100 utilizes a SURE localization module 105 that draws from a secure code signed DLL 114 and a user developed SURE language pack 116 described in further detail below. The localization module 105 includes a call intercept module 108, a resource check module 112, a language pack load module 115, a resource rule check module 118, and a dialog pad module 122.

Intercept module 108, in embodiments of the present invention, intercepts the resource after the resource is loaded by the resource loader module 104 from the MUI DLL 110. Any of a number of known methods may be used to intercept the resource loading functions (or API's). A number of intercept methods are well known. Examples include overwriting the start of the function itself in memory, known as installing a detour, or detouring. Another exemplary method overwrites the import address table. Further examples of interception methods are described in an overview article on patching by Yariv Kaplan. One preferred method of detouring is one in which binary functions are intercepted by rewriting one or more target function images. Detouring replaces the first few instructions of the target function with an unconditional jump to a user-provided detour function and preserves the target function instructions in a trampoline function. The detour function can either replace the target function or extend its semantics by invoking the target function as a subroutine through the trampoline. The detour is preferably inserted at execution time such that the procedures in a DLL can be detoured in one execution of an application, while the original procedures are not detoured in another execution running at the same time.

Once an intercepted call is received, the call intercept module 108 communicates with the resource check 112. This module queries whether the resource transferred from the MUI DLL 110 into the resource loader module 104 has an identifier that matches one of the identifiers in code signed SURE dynamic link libraries or databases (SURE DLL's) 114. The identifiers in the code signed DLL 114 signify those resources that the application developer gives permission for a user to translate, i.e. for which authorization is given for translations to be generated. This is done by checking the resource identifier against a list inside the code signed SURE DLL 114. The code signed DLL (or database) 114 cannot be modified by a user. The code signing itself also prevents anyone from adding additional resources to the files in this library. The SURE DLL 114 contains a list of the resource identifiers for all of the resources that are authorized to be translated. For each one of these it also has a list of verification rules. This file is the same for any SURE language.

It is to be understood that throughout this specification the code signed DLL 114 is simply one type of secure data structure that can be used. Any database, file, file set, or DLL can perform this function so long as it cannot be modified in any way by an unauthorized user. Authorization is preferably limited to the originator/developer of the calling application or operating system itself. In this way, the code signed DLL 114 is predetermined and not modifiable by a third party user. If the resource has a matching resource identifier, a translation of the resource, i.e. a localized resource or translation is loaded from a SURE language pack library or glossary file 116. The Language Pack library file 116 can be anything from an XML file through to a database. Translations could come from internet services or from machine translation tools rather than physical files.

Language packs 116 contain the language specific translations and differ from one language to the next. Typically these files are created by human translators (i.e., people who will provide a list of translations for their language). A fast lookup format development or SURE build tool could also be optionally provided to speed up runtime performance. The SURE Build Tools (which could be part of a SURE Kit) take the editable format of the translations (i.e., XML or text files) and convert them to a format that can be loaded quicker at runtime (e.g., a database)—this database is what is called the Language Pack.

An example of an XML file (that a build tool would take as input) might look as follows:

<resNode name=“Dialogs”>

<resource id=“string1”>

<text>This is the text to translate</text>
<reftext>This is reference text, such as the translation
in another language</reftext>
<rules>These are the verification rules. Examples:

<maximumlength> 5</maximumlength>
</rules>

</resource>

</resNode>

Users can translate this in any simple editor (e.g., the “Notepad” accessory application included in Microsoft Windows® operating system). A more advanced editor preferably is also provided (as part of the SURE language pack creation kit) that, for example, would color-code the bits that need to be edited, and check the verification rules as the user edits.

Another kit tool preferably would convert the edited text/xml file to a faster runtime format such as an Access Database or other fast binary format (i.e., the language pack 116.)

One exemplary verification rule is Maximum Length (which could appear in the editable file as “<maximumlength>5</maximumlength>”. This rule verifies that the translated resource, or string is not longer than an allowable limit. For example, if the maximum length is 5, the string “Hello” would be passed, but the string “Bonjour” would fail.

Another exemplary verification rule is a required placeholder, i.e. a case where a portion of a string must remain present. For example, a string like “Hello % s” might need to be translated. The translator would be allowed to move the “% s” portion around in the string, because it is replaced by another value at runtime (e.g. by a person's name). However, the verification rule would not allow removal of the “% s” substring. If it were removed (by the user creating a language pack, for example) then the verification would fail.

The format of the language pack databases will most likely be published so that users could write their own tools to create them independently. Note that this will not be the case for the code signed resource list files (i.e., the SURE DLL 114), where every effort is taken to protect the format and content from hacking or reverse engineering by closely controlled access authorization. Thus the code signed dynamic link library 114 is a library that cannot be modified by a user, i.e. anyone other than one authorized by the original owner/developer of the calling application or operating system.

Unlike MUI files, the language pack files do not have to be stored in a folder that is dependant on the target language. For instance, Microsoft's Office® German MUI files are stored in a “1031” folder (which happens to be the LCID or Language Code for German). In contrast, a German SURE language pack could be in “\program files\SURE\German” or “\program files\SURE\1031” or “\mymachine\mylanguages\myGerman”. In other words, this can be a location chosen by the user, and the SURE tools can easily be configured to point to any location (local machine, remote server or even internet).

The language pack load module 115 receives instruction from the resource check module 112, that the called resource is matched in the SURE DLL. The language pack load module 115 then retrieves the required language pack 116. The resource string or file is checked for compliance with key restrictions and rules contained in the code signed SURE DLL 114 in the resource rule check module 118 The SURE DLL's contain both the allowable resource identifiers and a list of rules to go with each of these resource identifiers. These restrictions are preferably stored in a format that is quick to parse and validate. Modifications are made to the resource string to ensure that the base (or source) language hotkey remains in the resource. This is because translators cannot adjust hotkeys, as such adjustment would impact functionality of the underlying application and/or operating system.

If the translation loaded in the load module 115 from the language pack 116 complies with all the verification rules in the code signed SURE DLL 114 as determined in the check module 118, the translated dialogs, if any, are padded in the padding, i.e., size dialog module 122 as called for by the resource rules. In module 122, the sizes of controls in dialogs may need to be resized or repositioned to accommodate long translated strings. If they are not resized or repositioned the translated text will not fit in the available space and will be truncated or cut. The translated resources are then passed through the resource loader 104 to the calling application 102 or data structure, or, if it were the operating system itself that made the call, to the operating system.

The application 102 represents any of a wide variety of possible software products including but not limited to a word processor, spreadsheet, Internet browser, database, operating system, and others. The base application may be developed in and for a specific language. For example, a product developed in the United States may be developed in English. Alternatively, the base product may be language neutral. That is, the base product may be developed in such a manner as to have no reference in its user interface or other elements written to a specific language. The MUI DLL 110 provides full translations for multiple languages that have been fully tested and provide full functionality to the application. In other cases, the base application may be written with only minimal reference to a specific language to facilitate testing of the base product during development.

Again, the MUI DLL 110 provides the translations for a number of specific languages. In contrast, the user defined language packs and the use of a secure data store such as a code signed SURE DLL 114 permits virtually any language to be utilized in an application and accommodates thousands of languages or dialects that are non-mainstream languages. The user defined language packs require no interaction with the software developer (original application owner of application 102) to use and thus these language packs can be freely developed and disseminated via the internet and other media, without compromising the functionality of the underlying application 102.

In embodiments of the present invention, because critical resources are not translated, non-translated resources remain in the base language thus ensuring security of the underlying program. The SURE language packs are language neutral. They are just collections of glossary files that have a one to one correspondence with resources that can be translated. There is no enabling function with embodiments in accordance with the present invention. SURE functions purely as a translation layer.

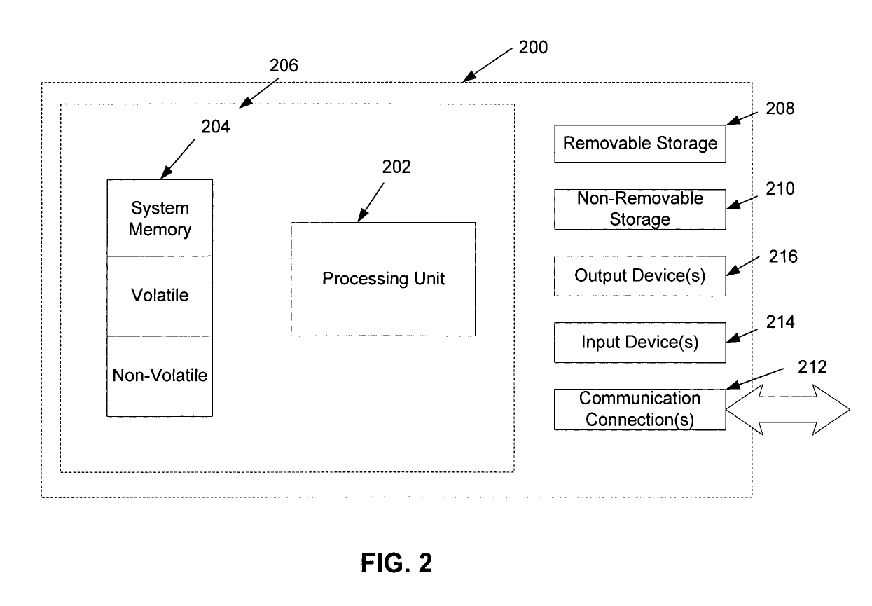

FIG. 2 illustrates an example of a suitable computing system environment on which embodiments of the invention may be implemented. This system 200 is representative of one that may be used as a stand-alone computer or to serve as a redirector and/or servers in a website service. In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 may also contain communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

A computing device, such as system 200, typically includes at least some form of computer-readable media. Computer readable media can be any available media that can be accessed by the system 200. By way of example, and not limitation, computer-readable media might comprise computer storage media and communication media.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

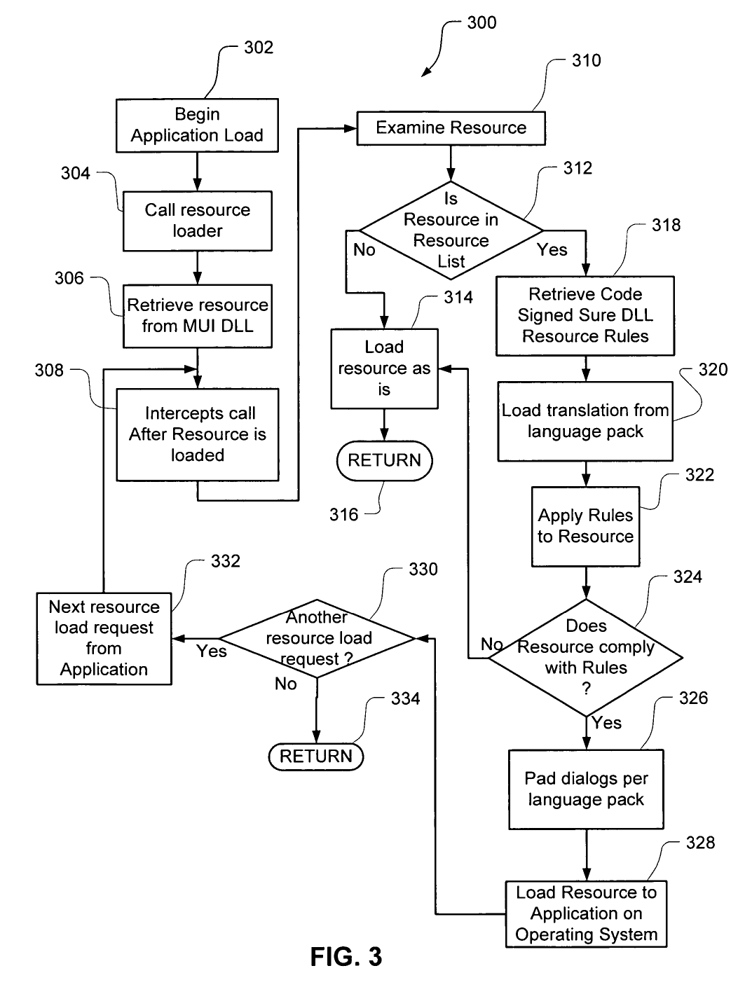

FIG. 3 is a flowchart illustrating operational flow 300 of the translation system and method according to one embodiment of the present invention. In this example, operation begins with application loading operation 302. In operation 302 the application load is commenced onto the operating system of the computing device 200. During this loading operation a call may be made to the resource loader 104. Control then passes to operation 304 where the application calls the resource loader. The resource loader in turn queries the MUI DLL 110 (i.e., resources). Control then transfers to operation 306.

In operation 306 the MUI DLL 110 is searched until a match is found and the called resource is identified. The called resource is retrieved and sent to the resource loader 104. Control then transfers to operation 308 where the application call is intercepted via the call intercept module 108. Control then transfers to operation 310.

Operation 310 examines the retrieved resource to obtain its identifier(s). Control then passes to query operation 312 in resource check module 112 which determine if it has an identifier that matches one of the identifiers stored in the code signed SURE DLL 114. If there is a match, then control passes to operation 318. If there is no match, then control passes to operation 314. In operation 314, the resource loaded from the MUI DLL 110 is passed to the operating system without modification in any way.

On the other hand, if there is a match, and control passes to operation 318, the code signed SURE DLL 114 is queried to retrieve all resource rules pertaining to the called resource. Control then passes to operation 320. In operation 320, a translation of the called resource is loaded in the load module 115 from the appropriate language pack 116 for the resource. This translation, i.e., the localized resource, is loaded and then compared, in check module 118, to the rules pertaining to that resource in operation 322. The applicable rules found in the SURE DLL 114 are then applied to the resource to verify that the translation complies with all applicable rules. Control then passes to query operation 324.

In query operation 324, the query is made by the check module 118, whether the localized resource complies with the applicable rules. If so, control passes to operation 328. If the resource does not comply with the applicable rules, the resource is not translated, but is passed to operation 314, where the resource is passed through the resource loader 104 to the calling application or operating system without translation. No modifications are made to the original loaded resource if the new translations fail on any of the rules. On the other hand, if the resource complies with all the applicable rules, i.e. verification is successful, then control passes to operation 326, where, in module 122, applicable translated or localized resource dialogs are padded in accordance with instructions provided by the language pack. At this stage modifications may also be made to the hotkeys where necessary. Control then passes to operation 328.

In operation 328, the localized resource has now been translated and therefore is passed or loaded back to the calling application and loaded on the operating system. Control then passes to query operation 330. Query operation 330 asks whether there are any further resource load requests in the resource loader 104. If so, control passes to operation 332 where the next resource load request is received from the calling application into the resource loader 104. If there is no further resource load request from the application or operating system, control returns to the resource loader 104 to await another request, in operation 334.

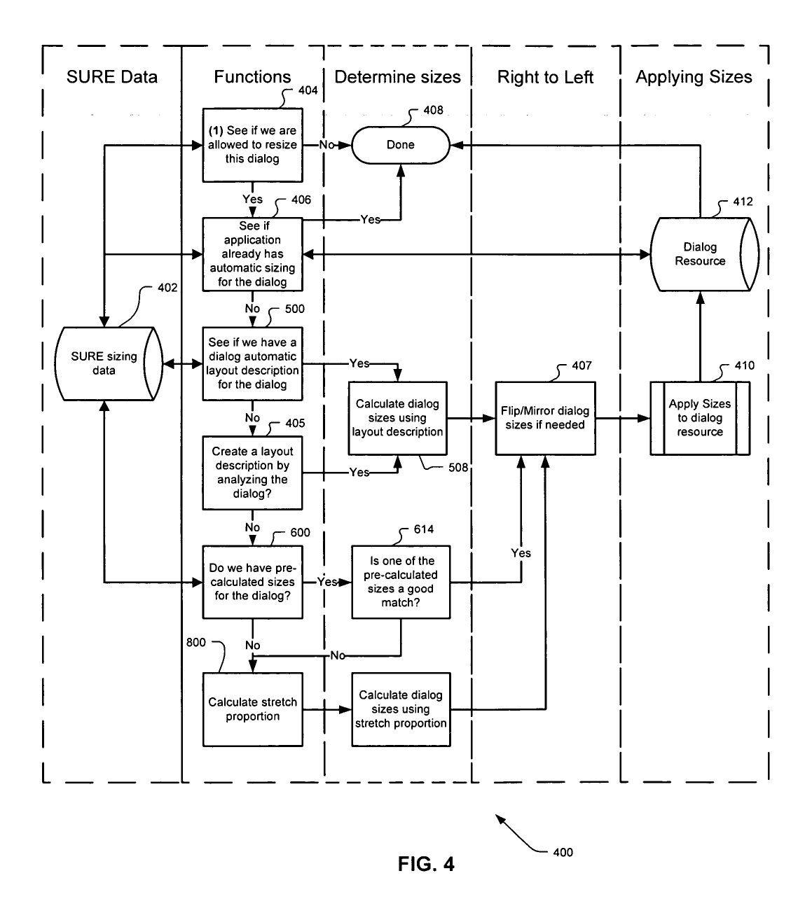

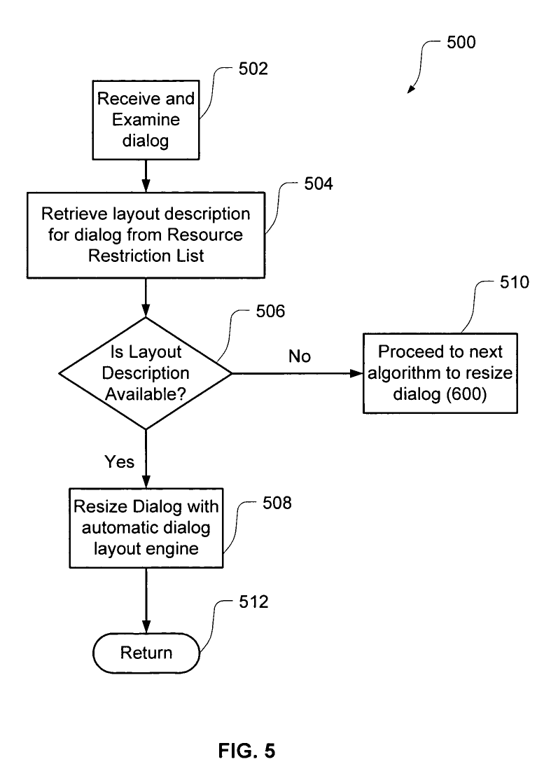

Referring back now to FIG. 1, the size dialog module 122 assesses whether the dialog box size needs to be modified. There are several methods of doing this evaluation and adjustment in accordance with the present invention. FIG. 4 is an overall flow concept diagram 400 of the methods that may be brought to bear on a particular dialog in order to determine how best to manage the task of resizing dialogs. As shown in FIG. 4, the process may be viewed as involving five distinct areas of operations demarked by the dashed lines: Sizing data, functions, size determination, right to left transformation, and size application. Once a dialog or string is translated and passes through module 118 and into module 122, as in FIG. 3, operation 326, the process 400 shown in FIG. 4 is invoked. The methods used may be all or some of the functions shown in FIG. 4. The sizing module 122 basically operates with SURE sizing data 402 that is found within the SURE DLL 114. A dialog or user interface string that passes to module 122 is first applied to function 404 in which the sizing data 402 is queried whether resizing of the dialog is allowed. Each string of dialog content in module 122 is stepped through a series of functions. First, function 404 retrieves sizing data 402 and determines whether the calling application or operating system permits resizing of the dialog. If not, flow transfers to operation 408 as no change can be made. If yes, function 406 queries the sizing data 402 and the dialog resource 412 to determine whether the calling application has an automatic sizing function for the dialog. If so, again flow transfers to operation 408. If not, the query is made in function 500 whether there is an automatic layout description available. This function 500 is described in more detail in FIG. 5. IF there is an automatic layout description then the dialog size is calculated using the layout description in operation 508. IF there is no automatic layout description the dialog is evaluated for whether a layout description can be generated by analyzing the dialog in function 405. If so, flow then goes again to operation 508.

Once a dialog size is generated in operation 508, then transpose operation 407 determines whether the translation language requires a different progression of letters, from right to left instead of from left to right, compared to the base language of the application or operating system. If so, the dialog size calculated is flipped or mirrored, as may be appropriate for the translated dialog. The size is then applied to the dialog resource in operation 410 and 412, and the flow proceeds again to operation 408, completing the process.

However, back in function 405, if analysis of the dialog cannot generate a layout, then a precalculated size function 600 is applied. If there are precalculated sizes a good match in operation 614, then that size is used and the flow proceeds to the flip/mirror operation 407 described above. On the other hand, if there are no precalculated sizes or there is no good match with one of the precalculated sizes, a proportional stretch function 800 can be applied. Then the flow proceeds through calculating the stretched proportions and then again to the flip/mirror function 407.

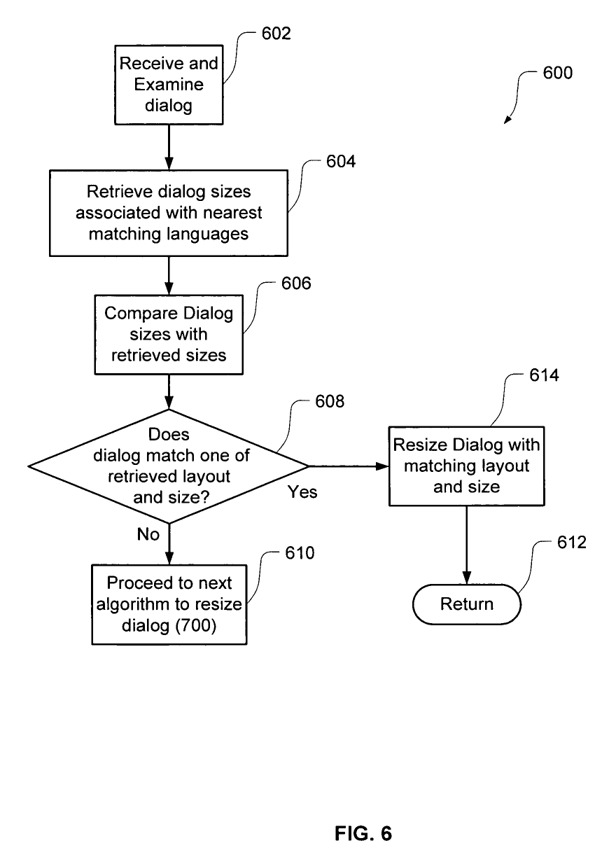

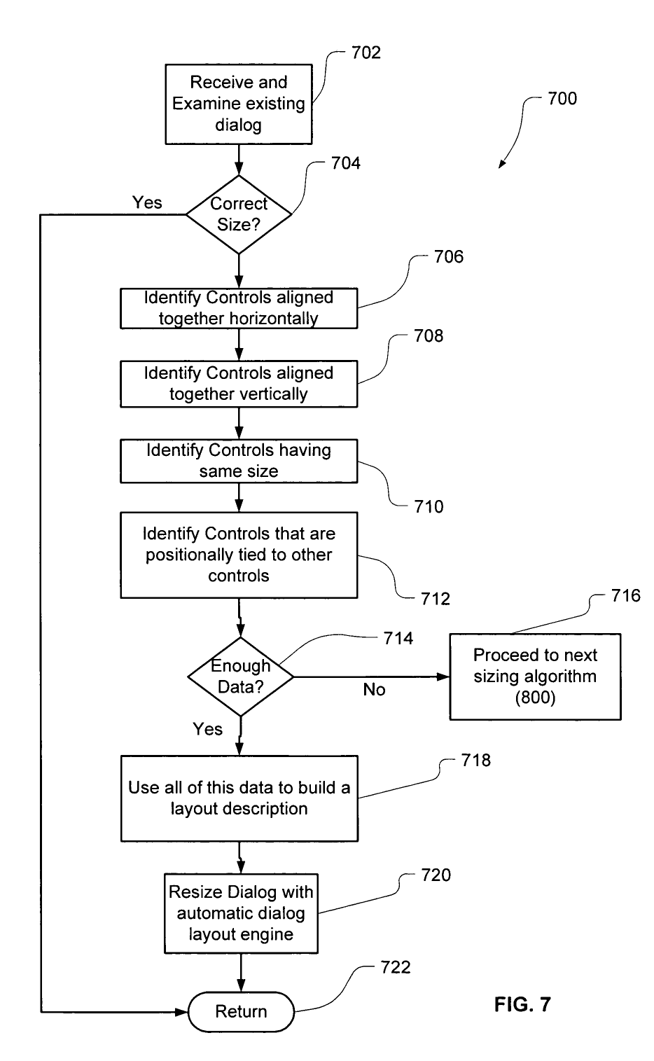

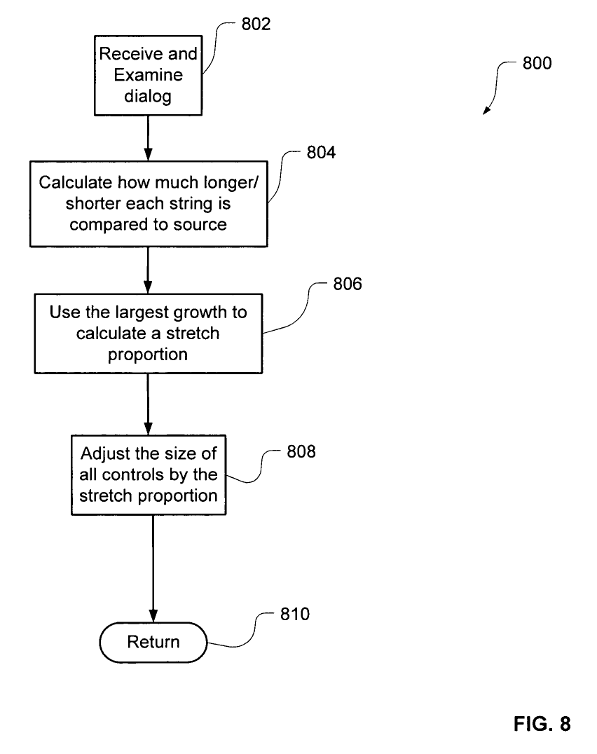

As stated above, the dialogs may be automatically adjusted at load time using layout descriptions (FIG. 5), using best matching dialog sizes (FIG. 6), using heuristics (FIG. 7), and/or proportional stretching the dialog (FIG. 8). These processes will now be described.

Referring now to FIG. 5, the dialog module 122 may utilize layout descriptions that are stored in the resource DLL 114. These layout descriptions for each dialog are preferably stored using the dialog resource identifier as a key in the Resource Restriction List in DLL 114. After a dialog is loaded into the resource loader 104, and after SURE has swapped in the translated strings, sizing is done by taking the layout description and translated strings and feeding them into a dialog automatic layout engine. This layout engine itself can be part of SURE, part of the application, part of the operating system or a separate sizing service. Typically the dialog automatic layout engine would be in the SURE engine, but alternatively SURE itself could call out to an external API to do the sizing and this API could be provided by applications or the operating system.

The operational flow 500 within padding module 122 is shown in FIG. 5. The operation begins in operation 502 where the translated dialog is received and examined. Control then transfers to operation 504. In operation 504, the layout descriptions for the dialog are retrieved from the Resource Restriction List associated with the resource identifier for the dialog. In query operation 506 the question is asked whether a layout description was available for the dialog as not all dialogs will have these. If the answer is yes, control transfers to return operation 508. On the other hand, if the dialog layout description is not available, control transfers to operation 510.

In operation 508, an automatic dialog layout engine is applied to the content of the dialog in order to resize the dialog in accordance with the layout description retrieved from the Resource Restriction List. When the dialog has been resized, control the transfers to return operation 512. In operation 510 control will pass to another method such as 600 or 700 to attempt to size the dialog (FIG. 6. or FIG. 7.)

Alternatively, padding module 122 may utilize a best matching routine 600 as shown in FIG. 6 to correctly size the dialog that has been translated. In this case operation begins in operation 602 where the translated dialog content is received and examined to determine whether a modification of size is needed. Control then transfers to operation 604. In operation 604, previously stored dialog sizes associated with the nearest matching languages are retrieved. Control then transfers to compare operation 606. Here, the translated dialog content and sizes are compared to the retrieved predetermined sizes to see if there is a match. If there is a match, or a close match, control transfers to operation 614 where the translated dialog is resized according to the previously stored layout and size. Control then transfers to return operation 614. If there is not a match, control passes to operation 610, where the next sizing algorithm is attempted. Control then passes to return operation 612.

Another method of padding is shown in FIG. 7. The sizing of dialogs may be performed using heuristic method 700. Operation begins, as in the previously described methods, by receiving and examining the translated dialog content in operation 702. Control then transfers to query operation 704, where the query is made whether the dialog is correctly sized. If it is, control then transfers to return operation 722. However, if the dialog is not correctly sized, control transfers to operation 706. In operation 706, the existing translated dialog content is examined to identify those controls that are aligned together horizontally. Control then transfers to operation 708. Here the dialog content is examined to identify those controls that are aligned together vertically. Control then transfers to operation 710 where those controls that have the same size are identified. Control then transfers to operation 712. In operation 712, some controls may be positionally aligned together, such as ones that lie to the left, right, top or bottom of other controls. If enough data has been gathered from operations 706, 708, 710 and 712 it will be possible to build a layout description. In query operation 714 the question is asked if there is enough data to build a layout description. There are many reasons why there may not be enough information, such as, if no controls have the same size or alignment. If the answer is yes then control transfers to operation 718. If the answer is no then control transfers to operation 716. In operation 716 control passes to the next sizing algorithm, shown in FIG. 8.

In operation 718 the data gathered in operations 706, 708, 710 and 712 is used to build a layout description.

Control then passes to operation 720 where the dialog is resized using the automatic layout engine based on the layout description built in operation 718.

After the dialog is resized in operation 720, control transfers to return operation 722.

Another method is shown in FIG. 8. This routine is typically undertaken when the others have not worked. The sizing of dialogs may be performed using a proportionate stretching method 800. Operation begins, as in the previously described methods, by receiving and examining the translated dialog content in operation 802. Control then transfers to query operation 804, where the display sizes of the translated strings are compared with the original strings, and a difference is calculated. Control then transfers to operation 806. In operation 806 this data is used to determine the largest growth and to calculate the maximum growth proportion. Control then transfers to operation 808. In operation 808 all dialog controls are adjusted by this growth proportion. Control then transfers to operation 810, the return operation.

After this step is completed there are steps needed to flip the dialog if necessary, as in operation 407 shown in FIG. 4. This is particularly required if the target language is not aligned the same way as the source language. For example, in Arabic, dialog characters are arranged right-to-left as opposed to English where they are arranged in a left-to-right reading order. A simple operation is used to create a mirror image of the dialog if needed.

In all of these methods 500, 600, 700 and 800, the resizing is completed without any enabling in the calling application itself, or knowledge in the application, or operating system, that the resizing has even happened. Thus the sizing and padding is completely transparent to the calling application. Note that these operations can be called in any order. It is also conceivable that data could be stored on what sizing algorithm to use for each dialog in the SURE code-signed DLL.

Another area of user interface adjustment is hotkeys. A hotkey is the access character used for quick access to functionality. The best example is the “File” menu item in most Windows applications. The underline of the “F” shows that this key can be used for quick access (e.g., by holding down the “Alt” keyboard key and the “F” keyboard key at the same time).

In conventional full translation the translators are free to pick and choose which hotkey characters to introduce. They can get it wrong and introduce problems and conflicts. Examples:
Hotkeys can be removed
Duplicate or conflicting hotkeys can be used (e.g., where two items on the same menu use the same hotkey)
Unavailable characters could be used. This is where a character that is not present on the target language keyboard is used.
Unsuitable characters could be used. This is where characters are chosen that do not look good when underlined. An example is the letter “i”.

Normally these problems are picked up and fixed during the testing phase in full localization. However, with a SURE system in accordance with the present invention, there are no such testing phases. The SURE solution implemented in accordance with embodiments of the present invention is quite simple:

First the translators don't get to change the hotkeys (they are not shown).

The source language hotkey is always used.

Here is an example of this. In the sample source string “View” below the hotkey is on the “V” &View

The Windows operating system will conventionally display the hotkey character underlined as shown. However, the actual string has an ampersand “&” character before the hotkey character. The operating system (or application) display functions remove the ampersand and replace it with underlining of the following letter. This is normally only performed for strings in pre-defined user interface elements. Examples include strings on menus, buttons, etc. View

Let us assume that a sample translation (French) for this string “View” is: Affichage

However, this does not have the character “V”. To get around this, SURE converts the string to the following (at load time): Affichage [&V]

In other words, we add the source language hotkey character to the end of the string, surrounded by square brackets.

This is then displayed as follows: Affichage [V]

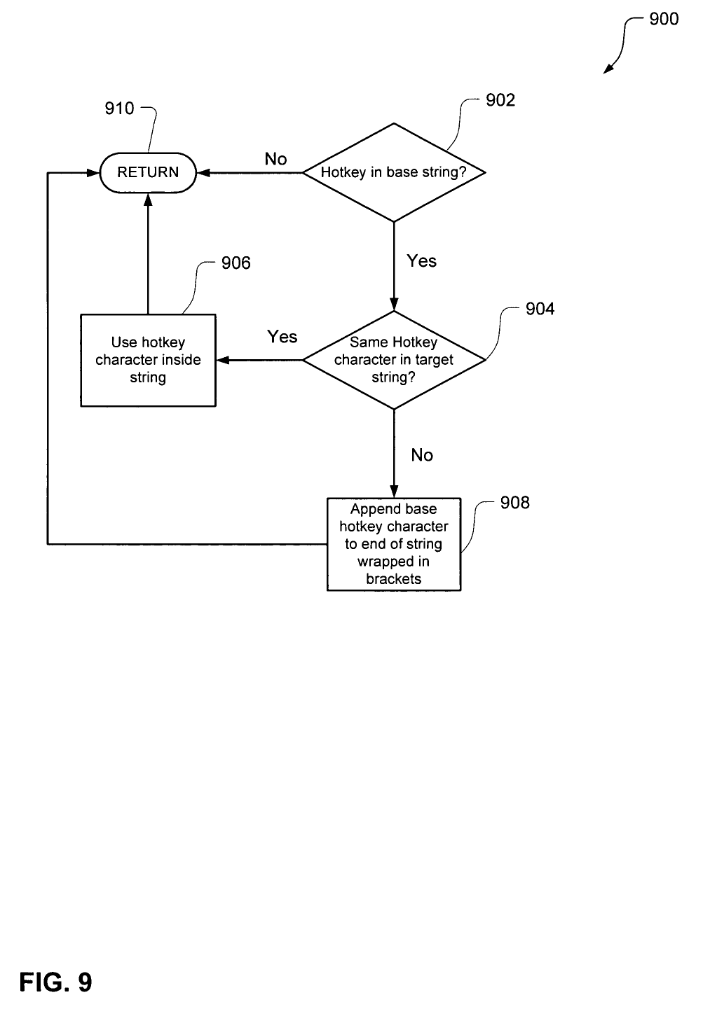

FIG. 9 is a diagram that illustrates the basic hotkey operations 900 in an embodiment of SURE in accordance with the present invention.

Query operation 902 first determines if there is a hotkey character used in the base string. If this result is No then control transfers to return operation 910 and no further action is taken. If the result of the query is Yes then control transfers to query operation 904.

In query operation 904 the question is asked as to whether the source hotkey character exists in the target string. If the answer is No control transfers to operation 908. If the answer is Yes then control transfers to operation 906.

In operation 906 the ampersand character is inserted into the target string just before the hotkey character. Control then transfers to return operation 910.

In operation 908 the following sequence of characters is appended to the end of the target string: space, opening bracket, ampersand, source hotkey character, closing bracket. Control then transfers to return operation 910.

The above sequence describes modification of the target strings so as to have hotkeys at the end of the strings surrounded by brackets. This modification is performed at load time. However, on operating systems such as Windows, users can choose not to have hotkey characters underlined. For example, on Windows, a user can disable this behavior by choosing Display settings in the Control Panel, choosing the Appearance tab, choosing Effects and un-checking the “Hide underlined letters for keyboard navigation until I press the Alt key”.

With this option the hotkey character will still be displayed at the end of the string as follows:

Affichage [V]

However, this is not desirable in embodiments of the present invention. Accordingly, a solution is needed to hide the entire hotkey in this case.

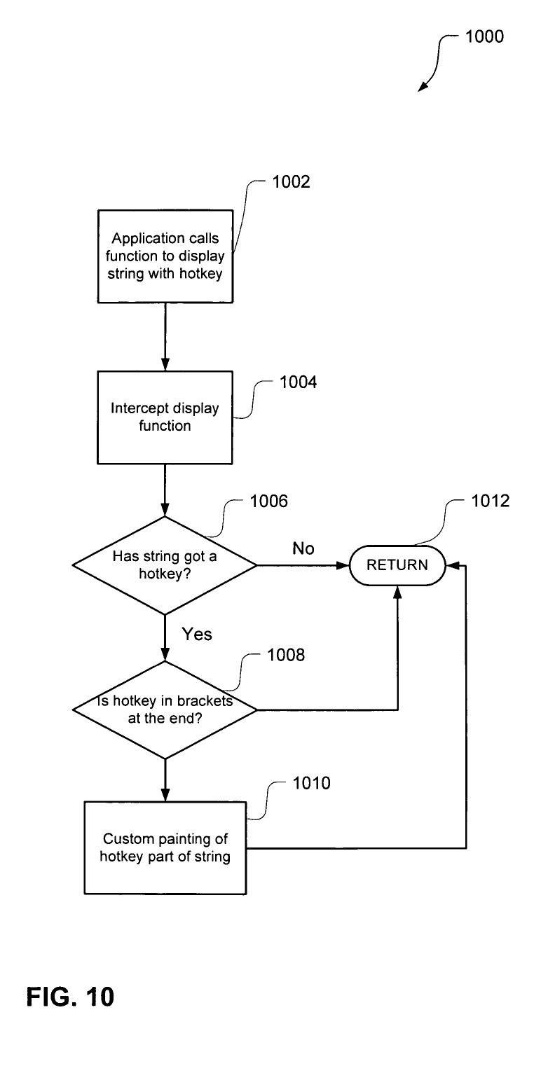

FIG. 10 describes how SURE can hide hotkeys or display them differently by double intercepting. As covered in FIG. 9, SURE modifies the string by intercepting it at load time. Now, in sequence 1000, the entire hotkey may be hidden or otherwise changed. Sequence of operations 1000 is preferably invoked if operation 908 has modified the hotkey string. Operation 1002 is where the application initiates the display of strings in the user interface. control then transfers to operation 1004.

In operation 1004 SURE intercepts the call to the display functions. The intercept is exactly the same set of techniques used to intercept resource load functions discussed previously. Control then transfers to query operation 1006.

Query operation 1006 determines if the string to be displayed contains a hotkey. If the answer is Yes then control transfers to operation 1008. If the answer is No then control transfers to Return operation 1012.

In query operation 1008 the question is asked as to whether the hotkey is at the end of the string (in other words was the string modified by operation 908 in FIG. 9). If the answer is No, then control transfers to return operation 1012. If the answer is Yes then control transfers to operation 1010. This operation 1010 performs custom painting of the hotkey character on the end of the string. Custom painting could mean not displaying the hotkey at all, including not displaying the brackets around the string. This would be performed if regular hotkey underlining is disabled.

However, if hotkey underlining was enabled, operation 1012 selects any one of a number of ways to display the hotkeys. This selection may be user defined or automatic by default. This can include (but are not limited to):

Displaying the hotkey character in different a different color

Displaying the brackets in a different color

Not displaying the brackets

Displaying different graphical types of brackets

Displaying the hotkey character in a different (e.g., smaller) font size

Displaying the hotkey character closer to the string (i.e., reducing the spacing)

Although the invention has been described in language specific to computer structural features, methodological acts and by computer readable media, it is to be understood that the invention defined in the appended claims is not necessarily limited to the specific structures, acts or media described. As an example, other types of data may be included in the language map in place of the string data discussed herein. Additionally, different manners of referencing the language specific data of the language map from the system calls in base product may be used. Therefore, the specific structural features, acts and mediums are disclosed as exemplary embodiments implementing the claimed invention.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. A method of localization of a software product comprising:
loading an application or an operating system wherein the application or operating system places one or more calls to a resource loader to load a resource;
intercepting the call in the resource loader after the called resource has been received in the loader;
converting the resource to a language specific localized resource if the called resource complies with one or more predetermined resource rules;
resizing one or more dialog associated with the localized resource if needed to accommodate the localized resource; and
transmitting the localized resource to the calling application or operating system.

2. The method of claim 1, wherein converting the resource to a language specific localized resource comprises:
comparing the called resource to a predetermined set of resource identifiers; and
if the called resource matches one of the identifiers, loading a translation for the resource from a language pack; and
comparing the translation for the resource to the one or more predetermined rules.

3. The method of claim 2, wherein if the resource does not comply with the one or more predetermined rules, loading the called resource without translation and without resizing to the calling application or operating system.

4. The method of claim 1, wherein if the called resource does not match the one or more predetermined resource rules, the transmitting operation comprises transferring the called resource without translation and resizing to the calling application or operating system.

5. The method of claim 1 wherein resizing the language specific localized resource comprises:
determining whether the localized resource needs to be resized; and
applying one of more resizing functions to the localized resource.

6. The method of claim 5 wherein one of the resizing functions comprises comparing a size of the dialog to predetermined sizes and selecting one of the predetermined sizes if there is a match.

7. The method of claim 6 wherein another one of the resizing functions comprises applying an automatic layout description to the dialog.

8. A system comprising:
a processor; and
a memory coupled with an readable by the processor and containing a series of instructions that, when executed by the processor, cause the processor to load an application or an operating system wherein the application or operating system places one or more calls to a resource loader to load a resource;
intercept the call in the resource loader after the called resource has been received in the loader;
convert the resource to a language specific localized resource if the called resource complies with one or more predetermined resource rules;
resize one or more dialog associated with the localized resource if needed to accommodate the localized resource; and
transmit the localized resource to the calling application or operating system.

9. The system of claim 8, wherein the series of instructions cause the processor to convert the resource to a language specific localized resource by:
comparing the called resource to a predetermined set of resource identifiers; and
if the called resource matches one of the identifiers, loading a translation of the resource from a localized language pack; and
comparing the translation of the resource to the one or more predetermined rules to verify that the translation complies with the one or more predetermined rules.

10. The system of claim 9, wherein the series of instructions cause the processor to load the called resource without translation and without resizing to the operating system if the translation of the resource does not comply with the one or more predetermined rules.

11. The system of claim 8, wherein the series of instructions cause the processor to convert the resource to a language specific localized resource by:
comparing the called resource to a set of resource identifiers; and
if the called resource matches one of the identifiers, loading a translation for the resource; and
comparing the translation for the resource to the one or more predetermined rules.

12. The system of claim 11, wherein the series of instructions cause the processor to transmit the translation of the resource to the calling one of the operating system, data or application if the translation matches the one or more resource rules.

13. The system of claim 8 wherein the series of instructions cause the processor to convert the resource to a language specific localized resource by:
comparing the called resource to a predetermined set of resource identifiers in a library that cannot be modified by an unauthorized user;
if the called resource matches one of the identifiers, loading a translation of the resource from a localized language pack; and
comparing the translation of the resource to the one or more predetermined rules.

14. The system of claim 13 wherein the library is stored in a code signed dynamic link library having a non-modifiable format.

15. A computer readable medium encoding a computer program of instructions for executing a computer process for localization, said computer process comprising:
loading one of an application, data or an operating system wherein one of the application, the data or the operating system places one or more calls to a resource loader to load a resource;
intercepting the call in the resource loader after the called resource has been received in the loader;
converting the resource to a language specific localized resource if the called resource complies with one or more predetermined resource rules;
resizing one or more localized resource dialogs if necessary to accommodate the localized resource; and
transmitting the localized resource to the calling one of the application, data or operating system.

16. The computer readable medium of claim 15, wherein converting the resource to a language specific localized resource comprises:
comparing the called resource to a predetermined set of resource identifiers; and
if the called resource matches one of the identifiers, loading a localized resource from a localized language pack for the resource; and
comparing the localized resource to the one or more predetermined rules.

17. The computer readable medium of claim 16, wherein if the resource does not comply with the one or more predetermined rules, loading the called resource without translation and without resizing to the calling one of the application, data or operating system.

18. The computer readable medium of claim 16, wherein if the resource does not comply with the one or more predetermined rules, loading the called resource without translation and resizing to the calling one of the application, data or operating system.

19. The computer readable medium of claim 15 wherein converting the resource to a language specific localized resource comprises:
comparing the called resource to a predetermined set of resource identifiers in a data structure that cannot be modified by a user; and
if the called resource matches one of the identifiers, loading a translation of the resource from a localized language pack; and
comparing the translation of the resource to the one or more predetermined rules.

20. The computer readable medium of claim 19 wherein the data structure is stored in a code signed dynamic link library.
